(19) United States
(12) Patent Application Publication
(10) Pub. No.: US 2014/0077906 A1
(43) Pub. Date: Mar. 20, 2014

(54) MICROSWITCH HAVING AN INTEGRATED ELECTROMAGNETIC COIL

(71) Applicant: HT MicroAnalytical, Inc., Albuquerque, NM (US)

(72) Inventor: Todd Richard Christenson, Albuquerque, NM (US)

(73) Assignee: HT MicroAnalytical, Inc., Albuquerque, NM (US)

(21) Appl. No.: 14/085,267

(22) Filed: Nov. 20, 2013

Related U.S. Application Data
(63) Continuation-in-part of application No. 13/764,424, filed on Feb. 11, 2013.
Application No. 13/764,424 is a continuation-in-part of application No. 13/587,398, filed on Aug. 16, 2012, now abandoned.
Application No. 13/587,398 is a continuation of application No. 13/028,855, filed on Feb. 16, 2011, now Pat. No. 8,258,900.
Application No. 13/028,855 is a continuation of application No. 11/367,890, filed on Mar. 3, 2006, now Pat. No. 7,999,642.
(60) Provisional application No. 60/658,902, filed on Mar. 4, 2005.
(60) Provisional application No. 60/658,957, filed on Mar. 4, 2005.

(51) Int. Cl. H01H 51/00; H01H 49/00

(52) U.S. Cl. CPC H01H 51/00; H01H 49/00
USPC 335/167; 335/2; 29/602.1

(57) ABSTRACT

A microswitch is disclosed, wherein the microswitch has (1) an electrical path between a first terminal and a second terminal and (2) a closed-loop magnetic path for channeling a magnetic field through a working gap to efficiently actuate the microswitch, where the electrical path and the closed-loop magnetic path are path independent. The electrical path includes a laterally movable mechanically active element. The closed-loop magnetic path includes one or more integrated coils for generating the magnetic field. The microswitch comprises: an electromagnetic module, which includes the one or more coils and some of the magnetic element of the closed-loop magnetic path; and a switch module, which includes the switching elements and the remainder of the magnetic elements of the closed-loop magnetic path. After the modules are joined the magnetic elements on both modules are magnetically coupled to collectively define the closed-loop magnetic path.

### CROSS REFERENCE TO RELATED APPLICATIONS

This case is a continuation-in-part of co-pending U.S. patent application Ser. No. 13/764,424, filed Feb. 11, 2013 (Attorney Docket: 515-006US3), which is a continuation-in-part of U.S. patent application Ser. No. 13/587,398, filed Aug. 16, 2012 (Attorney Docket: 515-006US2), which is a continuation of U.S. patent application Ser. No. 13/028,855 (now U.S. Pat. No. 8,258,900), filed Feb. 16, 2011 (Attorney Docket: 515-006US), which is a continuation of U.S. patent application Ser. No. 11/367,890 (now U.S. Pat. No. 7,999,642), filed Mar. 3, 2006 (Attorney Docket: 515-003US), which claims priority to U.S. Provisional Patent Application Ser. No. 60/658957, filed Mar. 4, 2005 (Attorney Docket: 31790-05-01P) and U.S. Provisional Patent Application Ser. No. 60/658,902, filed Mar. 4, 2005 (Attorney Docket: 31790-05-02P). Each of these cases is incorporated by reference herein.

The underlying concepts, but not necessarily the language, of the following cases are also incorporated by reference:

(1) U.S. patent application Ser. No. 12/725,168, filed Mar. 16, 2010 (Attorney Docket: 515-001US);

(2) U.S. patent application Ser. No. 12/406,937 (now U.S. Pat. No. 8,327,527), filed Mar. 18, 2009 (Attorney Docket: 515-004US); and

(3) U.S. Provisional Patent Application Ser. No. 61/038,340, filed Mar. 20, 2008.

If there are any contradictions or inconsistencies in language between this application and one or more of the cases that have been incorporated by reference that might affect the interpretation of the claims in this case, the claims in this case should be interpreted to be consistent with the language in this case.

### FIELD OF THE INVENTION

The present invention relates to magnetically actuated devices in general, and, more particularly, to electromagnetic switches.

### BACKGROUND OF THE INVENTION

Magnetically actuated switches control the flow of electric current based on the application of a magnetic field. Such a device typically includes a contact gap between a pair of electrical contacts, at least one of which is disposed on a movable element. The switch is arranged so that an applied magnetic field produces magnetic flux in a working gap, which gives rise to a force on the movable element to control the contact state of the contact gap. In some devices (referred to as “normally open” devices), the contact gap exists until the application of a magnetic field. The force causes the movable element to close the gap and enable current to flow between the electrical contacts. In other devices (referred to as “normally closed” devices), the electrical contacts are in physical and electrical contact until the force moves the movable element and separates the electrical contacts to establish the contact gap and disable current flow between the electrical contacts.

Microfabrication technologies, such as Micro-Electro Mechanical Systems (MEMS) technology and nanotechnology, have enabled the fabrication of extremely small switches (e.g., microswitches on the order of millimeters or smaller). These fabrication technologies are normally based on planar processing techniques first developed for use in the integrated circuit industry; however, in MEMS and nanotechnology they are used to form small structural elements that are movable relative to an underlying substrate (i.e., a “mechanically active element”).

In order to fabricate a microfabricated mechanically active element, alternating layers of structural material and sacrificial material are deposited on a substrate and patterned into their desired shapes. By appropriately shaping each successive layer of structural material, a three-dimensional structure can be developed from multiple two-dimensional layers. Those elements of the structure intended to be mechanically active are formed such that their structural material is fully encased in sacrificial material. This provides a barrier between that structural material and the underlying substrate, as well as other structural material on the substrate. After the micromechanical device is fully formed, the sacrificial material is selectively removed in a “release etch,” which frees the structural material that defines the mechanically active element.

Microswitches have several advantages over their macro counterparts, including smaller size and lower power requirements. In addition, they can be lower cost due to the use of relatively inexpensive batch manufacturing. Further, their small size and low actuation power requirements enable device functionality and applications that cannot be addressed by macro switching devices.

Unfortunately, microfabrication techniques are not well suited to the formation of a moving element whose quiescent state is that of physical contact with another element (e.g., a normally closed switch). This is due to the sacrificial material that encases any mechanically active elements during formation. After the release etch, therefore, mechanically active elements are left separated from other structural elements (or the substrate) by gaps that are substantially equal to the thickness of the sacrificial material removed during the release etch. As a result, prior-art microsystem-based switching devices have been principally limited to normally open operation. In many applications, however, a normally closed configuration would be desirable because it can offer greater system design flexibility and, often, reduced system complexity.

In addition, in prior-art devices, the magnetic field is typically applied by physically moving a permanent magnet into and out of magnetic coupling with the movable element. In some applications, however, it is preferable to use an electromagnet affixed near the movable element. This enables the magnetic field to be generated and coupled with the movable element by inducing a flow of electric current in the coil of the electromagnet. When no electric current flows through the coil, no magnetic field is generated and, thus, the movable element remains in its quiescent position. To provide efficient coupling between the electromagnet coil and the working gap, a readily magnetized or “soft” ferromagnetic material is often employed in the magnetic path. Further coupling efficiency is obtained when the soft ferromagnetic path is compact and consequently short with large cross sectional area. The force exerted on the switch contacts due to the magnetic field produced by the electromagnetic coil is a function of the material used in the device, the geometry of the coil, the number of turns in the coil itself, and the magnitude of the current through the coil. Typically, the coil includes a large number of turns to keep the magnitude of the first current small.

Implementing an integrated electromagnetic coil within a planar process can be quite challenging, however. As a result, prior-art MEMS-based switching devices have relied either upon coils having poor magnetic coupling or macro coils that are integrated with the switch in hybrid fashion. Coils having poor magnetic coupling require a great deal of electrical power to generate sufficient force to energize the switch, however. This has significantly limited their widespread adoption. Macro coils that are formed separate from the switch and then integrated with the device significantly increase packaging cost and device size. In addition, they also typically have poor assembly tolerances that can lead to wide variation in the operating characteristics for a given device design.

Improved switch functionality and integrated electromagnetic coils would provide microswitches with greater flexibility, as well as improved utility.

### SUMMARY OF THE INVENTION

The present invention enables a microswitch that overcomes some of the limitations and drawbacks of the prior art. Embodiments of the present invention comprise: (1) a magnetically actuated movable contact that selectively moves in a plane parallel to its underlying substrate; (2) one or more monolithically integrated planar coils able to generate a magnetic field for displacing the movable contact from its quiescent position; and (3) a closed magnetic path for efficiently channeling the generated magnetic field through the microswitch.

An illustrative embodiment of the present invention is a microswitch that includes (1) a closed-loop magnetic path for actuating the switch and (2) an electrical path between two terminals, wherein electrical communication between the terminals is based on the presence of a magnetic field in the magnetic path. The microswitch is formed of an electromagnetic module and a switch module, which are bonded together to collectively define the complete switch structure. In some embodiments, a microswitch includes multiple electromagnetic modules.

The closed-loop magnetic path is magnetically coupled with two monolithically integrated planar coils for generating the magnetic field. The magnetic path includes a ferromagnetic armature that is movable with respect to the planar coil, magnetic poles that are separated from the armature by a pair of working gaps, and path segments that collectively channel the magnetic field through the working gaps.

The electrical path includes a first and second terminal, a movable contact that is operatively coupled with the armature and electrically connected to the first terminal, and a stationary contact that is electrically connected with the second terminal. The movable contact is selectively movable in a plane that is substantially parallel with the switch substrate.

In the absence of electric current flowing in the planar coil, the movable contact has a quiescent position in which it is in physical and electrical contact with the stationary contact, thereby enabling electrical communication between the first and second terminals. When a suitable current flows through the planar coil, however, it generates a magnetic field that is channeled to the working gaps and that is sufficient to move the armature from its quiescent position, thereby physically separating the movable contact and stationary contact and breaking electrical communication between the first and second terminals.

In some embodiments, the movable contact is disposed at the free end of a movable element, which is mechanically coupled with the armature. When the armature is moved by the magnetic field, it induces the free end to move. As a result, the movable contact is moved from its quiescent position. In some embodiments, the movable contact is not in contact with the stationary contact and motion of the armature in response to an applied magnetic field drives the movable contact into physical contact with the stationary contact. In some embodiments, the armature is magnetically and electrically isolated from the cantilever element.

In some embodiments, the movable contact is in contact with a first stationary contact in its quiescent position. When the armature is moved by the magnetic field, the movable contact moves to a second position in which it is in contact with a second stationary contact. In some embodiments, the movable contact makes contact with the second stationary contact before it disconnects from the first stationary contact.

An embodiment of the present invention is a microswitch comprising: (1) a first substrate that defines a first plane; (2) a first coil operative for providing a magnetic field, the first coil being substantially planar in a second plane that is substantially parallel with the first plane, wherein the first coil and the first substrate are monolithically integrated; (3) an electrical path between a first terminal and a second terminal, the electrical path comprising; (a) a first contact that is selectively movable in a third plane that is substantially parallel with the first plane, the first contact having a first position and a second position in the third plane, and the first contact being in electrical communication with the first terminal; and (b) a second contact that is in electrical communication with the second terminal; wherein the first contact and second contact are electrically connected when the first contact is in the first position and not electrically connected with the first contact is in the second position; and (4) a closed-loop magnetic path operative for channeling the magnetic field through an armature that is mechanically coupled with the first contact; wherein the magnetic field gives rise to a force on the armature that moves the first contact between the first position and the second position; and wherein the electrical path and the closed-loop magnetic path are path independent.

### BRIEF DESCRIPTION OF THE DRAWINGS

FIG. 1 depicts a schematic drawing of a first microswitch in accordance with the prior art.

FIG. 2 depicts a schematic drawing of a second microswitch in accordance with the prior art.

FIG. 3 depicts a perspective view of a microswitch in accordance with an illustrative embodiment of the present invention.

FIG. 4 depicts operations of a method for forming a microswitch in accordance with the illustrative embodiment of the present invention.

FIGS. 5A and 5B depict schematic drawings of top and side views, respectively, of electromagnetic module 306 in accordance with the illustrative embodiment of the present invention.

FIGS. 6A and 6B depict schematic drawings of top and side views, respectively, of switch module 308 in accordance with the illustrative embodiment of the present invention.

FIG. 7 depicts sub-operations suitable for providing a switch module in accordance with the illustrative embodiment of the present invention.

FIG. 8A depicts a schematic drawing of a cross-sectional view of substrate 602 after the formation of spacer pads 612 through 618 and anchor 624.

FIG. 8B depicts a schematic drawing of a cross-sectional view of second substrate 800 after the structural material of movable element 318, interposer 626, and armature 320 has been undercut by the partial removal of release layer 804.

FIG. 8C depicts a schematic drawing of a cross-sectional view of substrates 602 and 800 during the bonding of anchor 622 and spacer pad 612.

FIG. 8D depicts a schematic drawing of a cross-sectional view of completed switch module 308 after the removal of handle substrate 802.

FIG. 9 depicts a schematic diagram of a cross-sectional view of microswitch 300 after the bonding of modules 306 and 308.

FIGS. 10A-B depict schematic drawings of a top view of salient features of a microswitch having a bi-stable latching mechanism, before and after latch actuation, respectively, in accordance with a first alternative embodiment of the present invention.

FIG. 11 depicts a schematic drawing of a top view of salient features of a second alternative embodiment in accordance with the present invention.

FIG. 12 depicts a schematic drawing of a top view of salient features of a third alternative embodiment in accordance with the present invention.

### DETAILED DESCRIPTION

As discussed in parent case U.S. patent application Ser. No. 13/764,424, microfabrication technology lends itself to the formation of switching elements that move in a direction perpendicular to its underlying substrate—referred to as “vertically actuated” elements. In part, this is because a working gap having a relatively large cross-section and small gap distance can be formed in a relatively straight-forward manner for a vertically actuated device. It is also relatively straightforward to form a planar coil that generates a magnetic field directed in the vertical direction. It is difficult, if not impossible, however, to form a vertically actuated device via microfabrication technology, where the device has an efficient magnetic circuit that has a compact magnetic path.

An additional challenge for vertically actuated switches is that their operating characteristics are determined primarily by the thin-film properties of the layers from which the movable elements are formed. Unfortunately, the mechanical properties of thin-film layers can vary significantly depending on deposition conditions and other factors. This can lead to inconsistent operating characteristics even among devices of the same design, and even among devices fabricated on the same substrate.

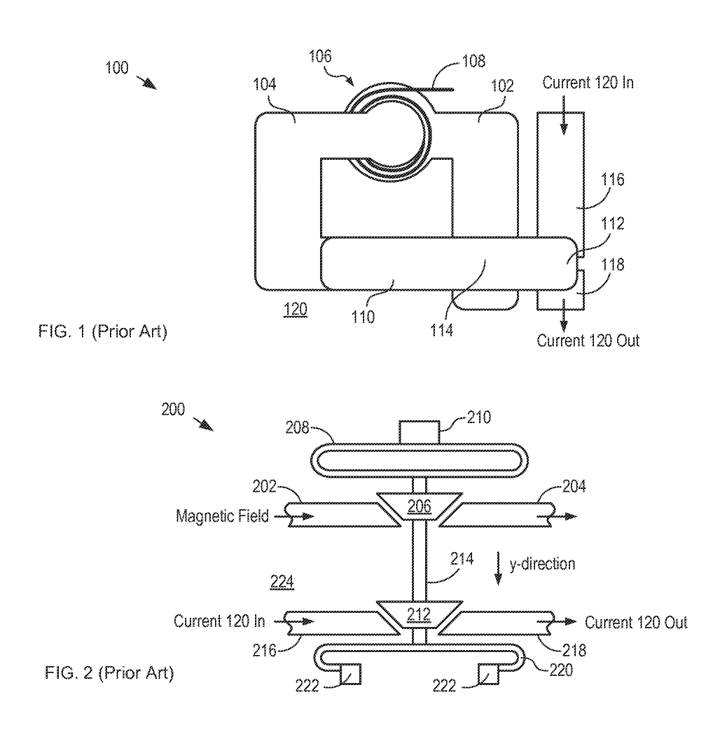

FIG. 1 depicts a schematic drawing of a first microswitch in accordance with the prior art. Switch 100 comprises magnetic elements 102 and 104, coil 108, cantilever beam 110, electrical contacts 116 and 118, and substrate 120. Examples of switches such as switch 100 are disclosed by Tai, et al. in U.S. Pat. No. 6,094,116, issued Jul. 25, 2000, which is incorporated herein by reference.

Magnetic element 102 is a layer of ferromagnetic material that is formed on the surface of substrate 120. Ferromagnetic material is material that has moderate or high magnetic permeability and is capable of channeling a magnetic field. Examples of ferromagnetic materials include permanent magnet material, nickel, nickel-iron alloy, iron, permalloy, supermalloy, Sendust™, and the like.

Magnetic element 104 is also a layer of ferromagnetic material that is formed on substrate 120 such that magnetic element 104 overlaps magnetic element 102 in region 106. Magnetic element 104 is fabricated using conventional planar processing operations such as those included in a MEMS fabrication process. Magnetic element 104 is formed having cantilever beam 110 whose free end 112 is suspended over magnetic element 102 at region 114 to form an air gap. Free end 112 is also suspended over electrical contacts 116 and 118.

Coil 108 is a planar coil of electrically conductive material, which is electrically connected to magnetic element 102. When a first current flows through coil 108, it generates a magnetic field. Coil 108 is wrapped around region 106 such that the magnetic couples into magnetic elements 102 and 104. Further, magnetic elements 102 and 104 and coil 108 collectively define a magnetic circuit that channels the magnetic field through the air gap located at region 114.

In response to the magnetic field, a magnetic force is developed on cantilever beam 110 that pulls free end 112 vertically downward (i.e., in a direction that is orthogonal with the plane of coil 108 and substrate 120) and toward magnetic element 102. As a result, free end 112 makes contact with substrate 120 and electrically shorts electrical contacts 116 and 118 thereby enabling the flow of current 120.

As indicated above, switch 100, like other vertically actuated devices, suffers from several disadvantages. First, it relies upon the fact that the planar coil and switching element are arranged in close proximity and that the switching element moves in a direction perpendicular to the plane of the coil. In addition, due to the small thickness of the magnetic circuit elements 102 and 104, the magnetic reluctance of the return magnetic circuit is high. As a result, the efficiency of the coupling between the magnetic field produced by coil 108 and the magnetic flux induced in the air gap 114 is low. A greater magneto-motive force from the coil is required, therefore, to produce a magnetic flux density in the air gap near the saturation flux density of the return magnetic circuit material. This magneto-motive force can be increased by either increasing the electric current through coil 108 or by increasing the number of turns included in coil 108. When higher current is used, the switch consumes much more power. When more coil turns are used, the planar layout of the magnetic circuit requires that the magnetic return path becomes substantially greater. This further increases magnetic reluctance and, therefore, further reduces coupling efficiency.

Since cantilever 112 moves in a direction perpendicular to the planes of coil 108 and substrate 120, the thickness and material properties of the layer from which the cantilever is formed primarily determine the mechanical behavior of the cantilever. For example, the required driving force, restoring force, resonant frequency, etc. are based on the thickness, density, residual stress, and residual stress gradient through the thickness of cantilever 112. Variations in these material properties from deposition to deposition are typical. As a result, the fact that cantilever 112 moves in a direction perpendicular to substrate 120 leads to:
i. variations in the operating characteristics of switch 100; or
ii. inconsistent operating characteristics between different switchs of the same design; or
iii. repeatability and reliability issues; or
iv. variation in the contact resistance between free end 112 and each of electrical contacts 116 and 118 from switch to switch; or
v. any combination of i, ii, iii, and iv.

Furthermore, the thickness of cantilever 112 is often limited to a maximum deposition thickness inherent to the deposition process used to form the cantilever layer. The design space for switches such as switch 100 is, therefore, limited.

Laterally actuated switches, on the other hand, employ a movable element whose motion is within a plane that is substantially parallel with its underlying substrate. In prior-art laterally actuated devices, the movable element is typically supported above the substrate by tethers designed to be resilient for in-plane (i.e., lateral) motion but stiff for out-of-plane (i.e., vertical) motion. The tethers and magnetic elements are defined by photolithography and etching to “sculpt” them into their desired shapes. As a result, such devices avoid some of the problems associated with vertically actuated devices—in particular, the operating characteristics (e.g., resiliency, actuation force, operating speed, etc.) of a laterally actuated device depend more upon the physical shape of its tethers, which is photolithographically defined, than upon the thin-film properties of the layers from which they are formed. Their operating characteristics, therefore, can be substantially decoupled from variations of film stress, stress gradients, thickness, and the like.

FIG. 2 depicts a schematic drawing of a second microswitch in accordance with the prior art. Switch 200 comprises magnetic elements 202, 204, and 206, springs 208 and 220, anchors 210 and 222, electrical contact 212, tether 214, electrical lines 216 and 218, and substrate 224. Examples of switches such as switch 200 are disclosed by Hill, et al. in U.S. Pat. No. 6,366,186, issued Apr. 2, 2002, which is incorporated herein by reference.

Magnetic elements 202 and 204 are layers of ferromagnetic material formed on the surface of substrate 224. Magnetic elements 202 and 204 collectively define a “magnetic flux path” for channeling an externally applied magnetic field.

Magnetic element 206 is an element comprising ferromagnetic material. Magnetic element 206 is suspended above substrate 224 by means of spring 208.

Spring 208 is a loop of structural material, such as silicon, polysilicon, etc. Spring 208 is formed into an oval shape using a conventional MEMS fabrication technique, such as deep reactive-ion etching (DRIE). Spring 208 is supported by anchor 210 above substrate 224. Spring 208 is substantially planar and lies in a first plane that is above and substantially parallel to a second plane that is defined by substrate 224.

By virtue of its shape, spring 208 is resilient in the first plane, but resistant to bending out of the first plane. Magnetic element 206 is attached to spring 208 such that it is also suspended above substrate 224. As a result, motion of magnetic element 206 in the first plane is enabled but motion of magnetic element 206 out of the first plane is inhibited.

Magnetic elements 202 and 204 are arranged to channel a magnetic field through magnetic element 206 and the gaps that separate the three magnetic elements. In operation, the magnetic field is externally applied by moving a magnetic element into proximity with switch 200.

Spring 220 is a curved structural element that is suspended above substrate 224 by anchors 222 and lies in the first plane. Similar to spring 208, spring 220 is resilient in the first plane but resists bending out of the first plane.

Electrical contact 212 is an electrically conductive element that is attached to spring 220 such that electrical contact 212 is suspended above substrate 224. As a result, motion of electrical contact 212 in the first plane is enabled but motion of electrical contact 212 out of the first plane is inhibited.

Tether 214 rigidly couples magnetic element 206 and electrical contact 212 such that they move together in the second plane.

Because tether 214 rigidly couples magnetic element 206 and electrical contact 212, the motion of magnetic element 206 moves electrical contact 212 (through tether 214) into physical contact with electrical lines 216 and 218. The physical contact electrically shorts electrical lines 216 and 218 and enables the flow of current 120.

Since the motion of electrical contact 212 is in a plane parallel to substrate 224, switch 200 overcomes some of the disadvantages discussed above, vis-à-vis switch 100. Specifically, the operating characteristics of switch 200 are determined primarily by photolithography.

Switch 200 still has several drawbacks, however. First, as disclosed by Hill, the magnetic flux path embodied by magnetic elements 202 and 204 needs to be aligned with an externally applied magnetic field in order to enable reasonably efficient coupling between the magnetic field and magnetic elements 202 and 204. The need for good alignment arises from the small cross-section of magnetic elements 202 and 204, which limits the coupling efficiency of the elements to an applied magnetic field. As a result, it is necessary to provide a large magnetic field to ensure that enough magnetic force is generated at the actuator.

The need to provide a high magnetic field, in turn, makes it difficult to integrate a suitable planar coil with the structure of switch 200. The challenge arises from the fact that an electromagnetic coil capable of generating a large magnetic field with sufficiently high quality factor would require an excessive amount of chip area.

j It is of note that in those embodiments wherein a coil is shown in Hill, the coil is depicted as external to the switch. Further, such coils are arranged to provide a magnetic field that is oriented perpendicular to the substrate through magnetic poles are formed on the top and bottom surfaces of a multi-substrate stack. These pole pieces direct the externally generated magnetic field perpendicular to the substrate stack and induce motion of a magnetically actuated electrical-contact element in a direction that is also perpendicular to each of the substrates. Such embodiments, of course, exhibit the same disadvantages described above, vis-à-vis switch 100.

In contrast to prior-art microswitches, such as those disclosed by Hill, the present invention is directed toward laterally actuated microswitches having monolithically integrated planar electromagnet coils, wherein the microswitches efficiently channel the magnetic field provided by the coils through one or more working gaps to give rise to a force on a movable element to actuate the switch. As a result, embodiments of the present invention enable highly efficient device actuation. For the purposes of this Specification, including the appended claims, the term “monolithically integrated” is defined as formed using planar processing technology either: in the body of a substrate, typically by etching into the substrate and/or; on the surface of the substrate, typically by depositing and patterning layers on the surface and/or; partially formed in and/or on multiple substrates and joined together. Examples include surface micromachining on a single substrate, bulk micromachining of a single substrate, integrated circuit fabrication on a single substrate, and fabrication wherein: (1) a first portion of a device is fabricated on a first substrate; (2) a second portion of a device is fabricated on a second substrate; (3) the first portion and second portion are bonded (e.g., via fusion bonding, thermo-anodic bonding, eutectic bonding, etc.) to complete the device; and (4) optional removal of one of the substrates. Monolithically integrated does NOT mean hybrid integrated (e.g., joined via solder bumps, etc.) or assembled, wherein a first device or system is joined with a second device or system after the first device or system is complete—for example, an electromagnet that is separately fabricated and then affixed to substrate comprising movable element actuator elements.

In addition, the present invention enables switches having a normally closed configuration. As discussed above, microfabrication techniques are not well suited to the formation of normally closed switches due to the need to encase each moving element in sacrificial material during fabrication.

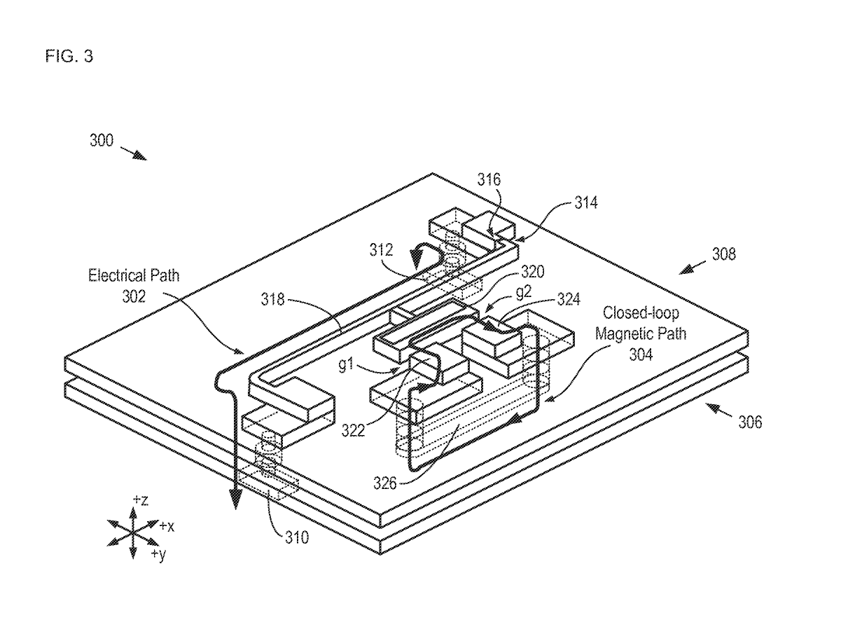

FIG. 3 depicts a perspective view of a microswitch in accordance with an illustrative embodiment of the present invention. Microswitch 300 is a normally closed, single-pole, single-throw (i.e., form B) switch for controlling electrical communication between a pair of electrical terminals located on the underside of the device. Microswitch 300 includes electrical path 302 and closed-loop magnetic path 304, each of is composed of elements formed on both electromagnetic module 306 and switch module 308. Electrical path 302 and closed-loop magnetic path 304 are fully defined by electromagnetic module 306 and switch module 308 once the modules are bonded together.

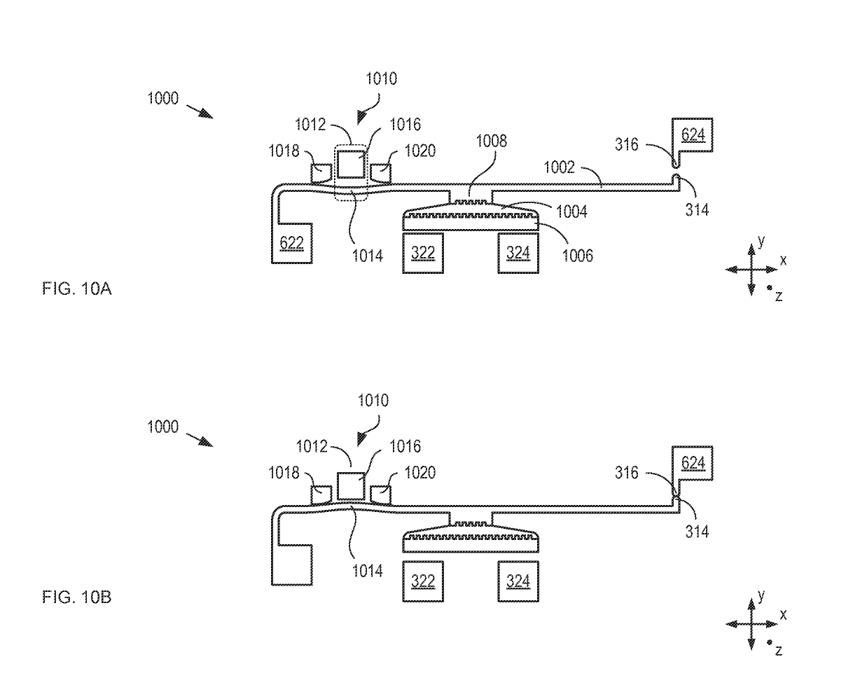

Electrical path 302 comprises terminals 310 and 312, contacts 314 and 316, and moveable element 318. Electrical contact 316 is disposed at the free end of movable element 318. The position of movable element 318 determines the state of physical contact between contacts 314 and 316. In the illustrative embodiment, for example, when movable element 318 is in its quiescent position, contacts 314 and 316 are in physical contact and electrical communication between terminals 310 and 312 is enabled. When movable element 318 is displaced from its quiescent position, contacts 314 and 316 are not in physical contact and electrical communication between terminals 310 and 312 is disabled. For the purposes of this Specification, including the appended claims, the “quiescent position” for a microswitch is defined as the configuration of the microswitch prior to application of a force on armature 320. In some embodiments, movable element 318 is is a position different from its “as-formed” position when a microswitch is in its quiescent position, as exemplified by microswitch 1000, which is described below and with respect to FIGS. 10A-B.

Although the illustrative embodiment of the present invention comprises a normally closed switch, it will be clear to one of ordinary skill in the art, after reading this Specification, how to specify, make, and use alternative embodiments of the present invention comprising switches that are not normally closed.

Closed-loop magnetic path 304 comprises armature 320 and magnetic poles 322 and 324, as well as through-wafer magnetic vias that extend through each of modules 306 and 308 to magnetic link 326. When microswitch 300 is in its quiescent state, armature 320 is separated from magnetic poles 322 and 324 by working gaps g1 and g2, respectively.

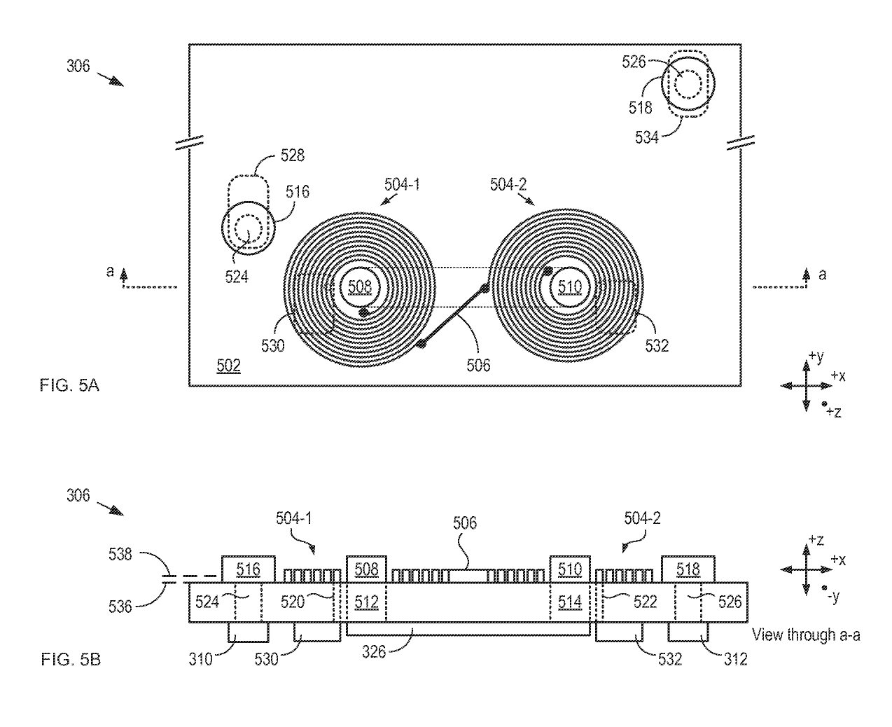

Closed-loop magnetic path 304 efficiently channels magnetic flux through gaps g1 and g2 to induce a lateral force (i.e., a force in the x-y plane) on movable element 318 and thereby the state of electrical communication between terminals 310 and 312. The magnetic flux is generated by a pair of planar coils (not shown in FIG. 3), which are disposed on electromagnetic module 306, as described below and with respect to FIGS. 5A-B.

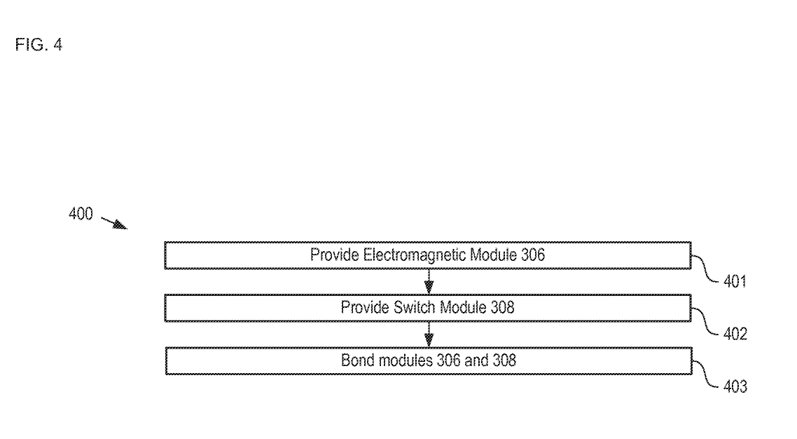

FIG. 4 depicts operations of a method for forming a microswitch in accordance with the illustrative embodiment of the present invention. Method 400 begins with operation 401, wherein electromagnetic module 306 is provided.

FIGS. 5A and 5B depict schematic drawings of top and side views, respectively, of electromagnetic module 306 in accordance with the illustrative embodiment of the present invention. Electromagnetic module 302 includes substrate 502, coils 504-1 and 504-2, interconnect 506, magnetic couplers 508 and 510, magnetic link 326, through-wafer magnetic vias 512 and 514, electrical couplers 516 and 518, through-wafer electrical vias 520, 522, 524, and 526, and contact pads 528, 530, 532, and 534. Methods suitable for the fabrication of electromagnetic module 306 are described in parent case U.S. patent application Ser. No. 12/725,168, which is incorporated by reference herein.

Substrate 502 is an alumina substrate suitable for use in a conventional microfabrication process. Other materials suitable for use in substrate 502 include, without limitation, semiconductors (e.g., silicon, silicon carbide, germanium, etc.), semiconductor- on-insulator substrates, compound semiconductors (e.g., gallium arsenide, indium phosphide, etc.), glasses, composite materials, metals, ceramics, and the like.

Each of coils 504-1 and 504-2 (collectively referred to as coils 504) is a substantially planar spiral of electrically conductive material disposed on the top surface of substrate 502. Coil 504-1 surrounds magnetic coupler 508 and coil 504-2 surrounds magnetic coupler 510 such that each coil can couple its generated magnetic flux into its respective magnetic coupler. Although the illustrative embodiment depicts substantially circularly shaped spirals, one skilled in the art will recognize that coils 504 can have any suitable shape. Each of coils 504 lies in plane 538. Plane 538 is substantially parallel to plane 536, which is defined by substrate 502. In some embodiments, each of coils 504 lies in a different plane, wherein each of these planes is substantially parallel to substrate 502. Although the illustrative embodiment comprises two coils 504, it will be clear to one skilled in the art, after reading this Specification, how to specify, make, and use alternative embodiments of the present invention that comprise any practical number of coils.

Coils 504-1 and 504-2 are electrically connected in series via interconnect 506 and form a continuous electrical path between contact pads 530 and 532. Contact pad 530 is electrically connected with coil 504-1 by through-wafer electrical via 520, while contact pad 532 is electrically connected with coil 504-2 by through-wafer electrical via 522.

Magnetic couplers 508 and 510 comprise ferromagnetic material and project above the top surface of coils 504.

Through-wafer magnetic vias 512 and 514 are through-wafer vias filled with ferromagnetic material.

Magnetic link 326 is a trace of ferromagnetic material that magnetically couples through-wafer magnetic vias 512 and 514.

Magnetic couplers 508 and 510 are magnetically coupled via through-wafer magnetic vias 512 and 514 and magnetic link 326 to collectively define a continuous sub-section of closed-loop magnetic path 304.

Electrical couplers 516 and 518 comprise electrically conductive material and project above the top surface of coils 504. Typically, the top surfaces of electrical couplers 516 and 518 and magnetic couplers 508 and 510 are coplanar so that each can bond with a mating element on with switch module 504, as described below. Electrical couplers 516 and 518 are electrically connected with contact pads 528 and 534 via conventional through-wafer electrical vias 524 and 526, respectively.

At operation 402, switch module 308 is provided.

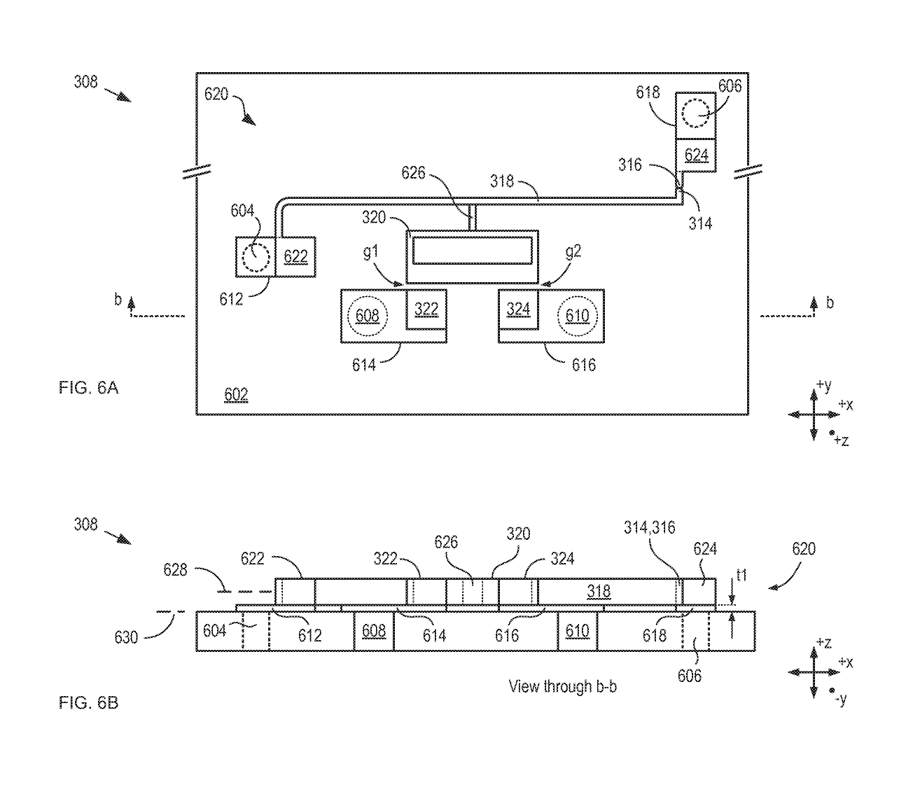

FIGS. 6A and 6B depict schematic drawings of top and side views, respectively, of switch module 308 in accordance with the illustrative embodiment of the present invention. Switch module 308 includes mechanically active elements of each of electrical path 302 and closed-loop magnetic path 304, as well as through-wafer vias and other structure that enable their electrical and magnetic coupling with mating elements located on electromagnetic module 306.

Switch module 308 comprises substrate 602, anchors 622 and 624, spacer pads 612, 614, 616, and 618, interposer 626, through-wafer electrical vias 604 and 606, through-wafer magnetic vias 608 and 610, contacts 314 and 316, movable element 318, armature 320, interposer 626, and magnetic poles 322 and 324.

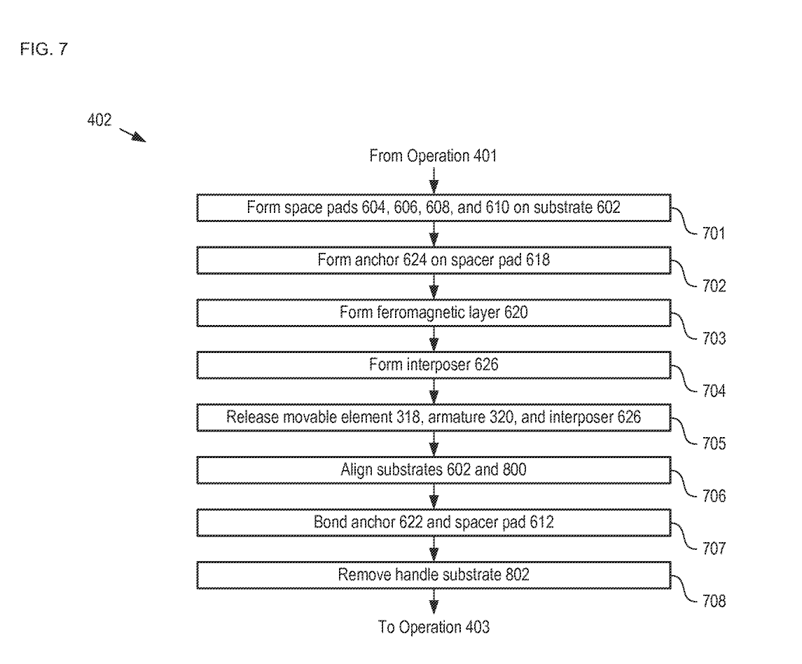

FIG. 7 depicts sub-operations suitable for providing a switch module in accordance with the illustrative embodiment of the present invention. Operation 402 begins with sub-operation 701, wherein spacer pads are formed on substrate 602.

Substrate 602 is an alumina substrate analogous to substrate 502 described above and with respect to FIGS. 5A-B. Substrate 602 comprises through-wafer electrical vias 604 and 606 and through-wafer magnetic vias 608 and 610.

Each of spacer pads 612, 614, 616, and 618 is a region of electrically conductive, ferromagnetic material that is suitable for mechanically bonding with the material of ferromagnetic layer 620, as described below. Spacer pads 612, 614, 616, and 618 are formed with a thickness of t1 via any of a number of conventional planar processing methods, or combinations thereof, such as evaporation, sputtering, electroplating, and the like.

Spacer pads 612 and 618 provide electrical connectivity between anchors 622 and 624 and through-wafer electrical vias 604 and 606, respectively. Spacer pads 614 and 616 enable magnetic coupling between magnetic poles 322 and 324 and through-wafer magnetic vias 608 and 610, respectively.

At sub-operation 702, anchor 624 is formed on spacer pad 618 via high-aspect-ratio fabrication methods, which are described in parent case U.S. patent application Ser. No. 12/725,168. Anchor 624 includes contact 316, which is electrically connected to through-wafer electrical via 606 through anchor 624 and spacer pad 618. Anchor 624 is a structure of electrically conductive material having a height suitable for enabling good physical and electrical contact between contact 316 and contact 318 when movable element 318 is in its quiescent position. In some embodiments, spacer pad 618 is not present and anchor 624 is formed directly on the top surface of substrate 602 and through-wafer electrical via 606.

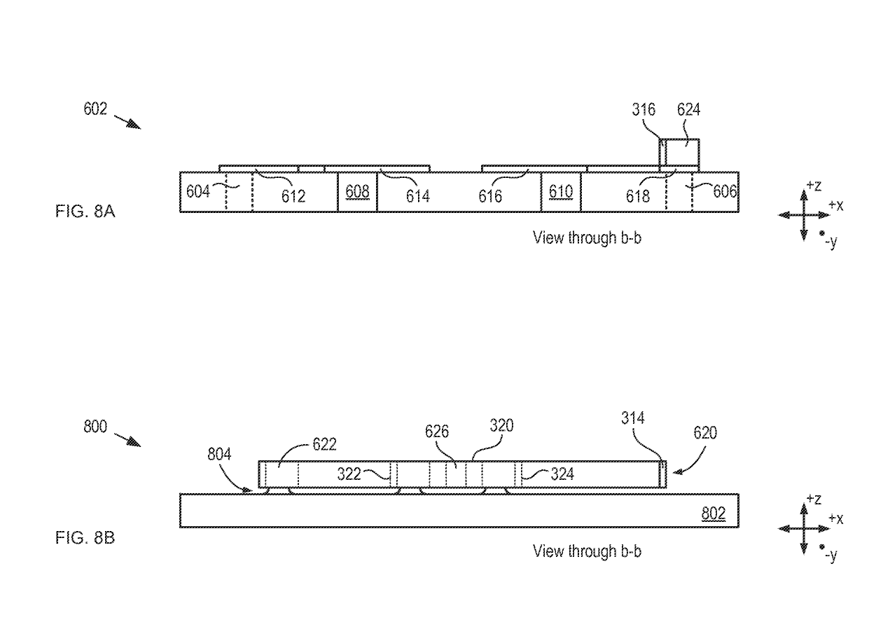

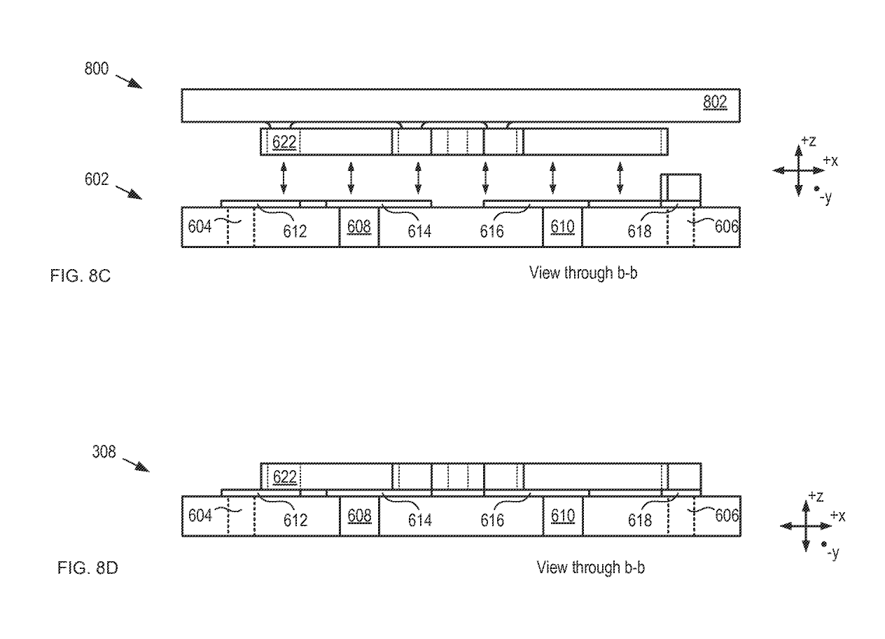

FIG. 8A depicts a schematic drawing of a cross-sectional view of substrate 602 after the formation of spacer pads 612 through 618 and anchor 624.

At sub-operation 703, ferromagnetic layer 620 is formed on second substrate 800. Second substrate 800 includes handle substrate 802 and release layer 804. In some embodiments, release layer 804 is not included in second substrate 800.

Ferromagnetic layer 620 includes anchor 622, movable element 318, armature 320, and magnetic poles 322 and 324. Ferromagnetic layer 620 is formed on release layer 804 using high-aspect-ratio fabrication methods.

Movable element 318 is a long beam of electrically conductive structural material having a substantially rectangular cross-sectional shape. The width of movable element 318 (i.e., its dimension in the y-direction) is much smaller than its height (i.e., its dimension in the z-direction). Typically, the aspect ratio of movable element 318 is at least 5:1 (height:width) so that, when mechanically active, movable element 318 moves substantially selectively in the x-y plane.

Movable element 318 cantilevers from anchor 322, which is a substantially rectangular block of electrically conductive structural material.

In some embodiments, anchor 622 and movable element 318 comprise ferromagnetic material.

Armature 320 is structure having a shape suitable for magnetically coupling with, and channeling magnetic field between, magnetic poles 322 and 324. Armature 320 comprises ferromagnetic material. The center region of armature 320 is removed to form an etch access feature that enables release layer 804 to be undercut from beneath the armature before the release layer is completely removed from beneath anchor 622.

In some embodiments, armature 320 is shaped to provide magnetic reluctance for the path between gaps g1 and g2 that is significantly lower than the magnetic reluctance from gaps g1 and g2 to movable element 318 so as to provide magnetic isolation between movable element 318 and closed-circuit magnetic path 304.

At sub-operation 704, interposer 626 is formed such that it mechanically couples movable element 318 and armature 320. Interposer 626 comprises a material, such as a dielectric, ceramic, and the like, which suitable for magnetically and electrically isolating armature 320 and movable element 318.

In some embodiments, interposer 626 is formed at the same time as anchor 624, movable element 318, and armature 320, and comprises the same ferromagnetic material. In some embodiments, interposer 626 is designed to have high magnetic reluctance so as to provide additional isolation between movable element 318 and closed-circuit magnetic path 304.

At sub-operation 705, release layer 804 is partially etched such that moveable element 318, armature 320, and interposer 626 are released from handle substrate 802 but anchor 622 and magnetic poles 322 and 324 are still affixed to the handle substrate.

FIG. 8B depicts a schematic drawing of a cross-sectional view of second substrate 800 after the structural material of movable element 318, interposer 626, and armature 320 has been undercut by the partial removal of release layer 804.

At sub-operation 706, second substrate 800 is flipped about the x-axis and aligned with substrate 602 such that contacts 314 and 316 are put into physical contact and a slight mechanical prebias is developed along the y-direction in movable element 318. Such mechanical pre-bias gives rise to high contact force that serves to reduce the electrical contact resistance between contacts 314 and 316.

At sub-operation 707, anchor 622 is bonded to spacer pad 612.

FIG. 8C depicts a schematic drawing of a cross-sectional view of substrates 602 and 800 during the bonding of anchor 622 and spacer pad 612.

At sub-operation 708, the rest of release layer 804 is removed to release ferromagnetic layer 620 from handle substrate 802.

FIG. 8D depicts a schematic drawing of a cross-sectional view of completed switch module 308 after the removal of handle substrate 802.

In some embodiments, switch 300 is a normally open switch and contacts 314 and 316 are not put into physical contact during operation 402.

Returning now to method 400, at operation 403, modules 306 and 308 are bonded such that: (1) through-wafer electrical vias 604 and 606 are joined with electrical couplers 516 and 518, respectively, where each through-wafer electrical via is bonded with its respective electrical coupler at a bonded interface that is electrically conductive; and (2) through-wafer magnetic vias 608 and 610 are joined with magnetic couplers 508 and 510, respectively, where each through-wafer magnetic via is bonded with its respective magnetic coupler at a bonded interface that has low magnetic reluctance.

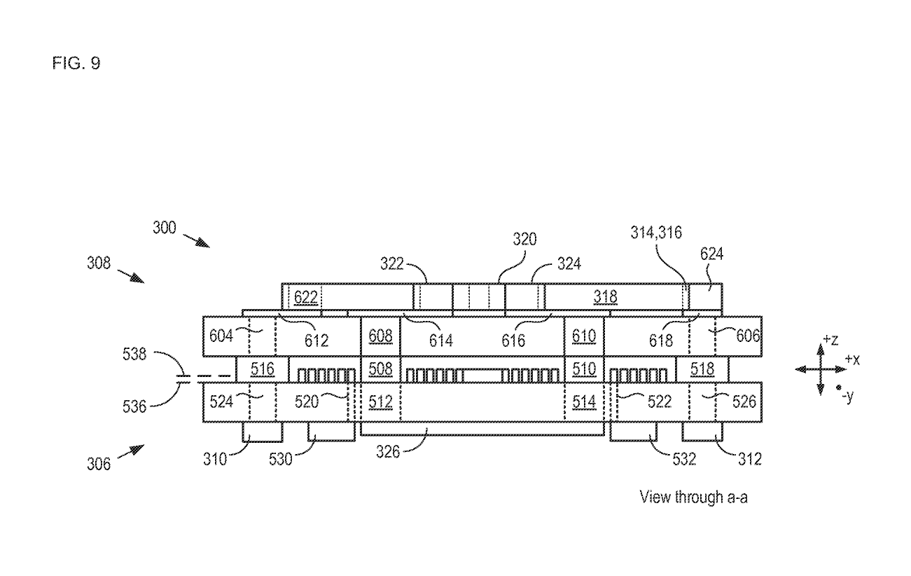

FIG. 9 depicts a schematic diagram of a cross-sectional view of microswitch 300 after the bonding of modules 306 and 308.

Typically, after the formation of switch 300 is complete, a cap layer is added to enclose the switch structure in a controlled environment.

After operation 403, each of electrical path 302 and closed-loop magnetic path 304 is completed.

Once complete, electrical path 302 is collectively defined by a first plurality of path elements that includes terminal 310, through-wafer electrical via 524, electrical coupler 516, through-wafer via 604, spacer pad 612, anchor 622, movable element 318, contacts 314 and 316, anchor 624, spacer pad 618, through-wafer electrical via 606, electrical coupler 518, through-wafer via 526, and terminal 312.

In similar fashion, completed closed-loop magnetic path 304 is collectively defined by second plurality of path elements that includes magnetic coupler 508, through-wafer magnetic via 608, spacer pad 614, magnetic pole 322, gap g1, armature 320, gap g2, magnetic pole 324, spacer pad 616, through-wafer magnetic via 610, magnetic coupler 510 through-wafer magnetic via 514, magnetic link 326, and through magnetic via 512.

It should be noted that electrical path 302 and closed-loop magnetic path 304 are path independent. For the purposes of this Specification, including the appended claims, the term “path independent” is defined as having no shared path elements. In other words, at no time does an electric signal travelling through electrical path 302 and a magnetic field channeled by closed-loop magnetic path 304 travel through the same path element.

In operation, a voltage differential is applied across contact pads 530 and 532 to energize coils 504 and generate a magnetic field. The generated magnetic field is oriented in a direction determined by the direction of current flow through each coil. Coils 504 are arranged such that each positively contributes to the magnetic flux in closed-loop magnetic path 304. In the illustrative embodiment, the generated magnetic fields of coils 504-1 and 504-2 are coupled into magnetic couplers 508 and 510, respectively. The magnetic field of coil 504-1 is directed in the positive z-direction, while the magnetic field generated by coil 504-2 is directed in the negative z-direction.

As the magnetic flux develops in closed-loop magnetic path 304 and gaps g1 and g2, it give rise to a force on armature 320 that attracts the armature toward magnetic poles 322 and 324, which pulls contact 314 out of physical contact with contact 316.

When current flow through coils 504 stops, the force on movable element 318 is removed and the stored mechanical energy in movable element 318 restores physical and electrical contact between contacts 314 and 316.

FIGS. 10A-B depict schematic drawings of a top view of salient features of a microswitch having a bi-stable latching mechanism, before and after latch actuation, respectively, in accordance with a first alternative embodiment of the present invention. Microswitch 1000 includes movable element 1002, interposer 1004, armature 1006, latching mechanism 1008, anchors 622 and 624, and magnetic poles 322 and 324.

Movable element 1002 is analogous to movable element 318 described above; however, movable element 1002 includes buckled-beam portion 1012, which is a element of a bi-stable latching mechanism for adjusting the quiescent position of contact 314, as described below.

Interposer 1004 is analogous to interposer 626 described above; however, interposer 1004 is designed for insertion into microswitch 1000 via hybrid integration (e.g., a conventional assembly process, such as press fitting, etc.). In some embodiments, interposer 1004 is a monolithically integrated element, such as is described above and with respect to FIGS. 6A-B.

Armature 1006 is analogous to armature 320 described above.

Interface 1008 extends laterally from movable element 1002 to receive interposer 1004.

Each of interposer 1004, armature 1006, and interface 1008 includes crenellations that facilitates their attachment. It will be clear to one skilled in the art, after reading this Specification, that myriad alternative mechanical features are known in the prior art for such a purpose.

Latching mechanism 1010 is a one-time-actuation system having two mechanically stable states. Latching mechanism 1010 comprises actuator 1012 and stops 1018 and 1020.

Actuator 1012 is a conventional electrostatic actuator that includes electrode 1016 and buckled-beam portion 1014, which is a portion of movable element 318 that is arranged with an initial portion that is “buckled” away from electrode 1016. In some embodiments, actuator 1012 is an actuator other than an electrostatic actuator. Actuators suitable for use in microswitch 1000 include, without limitation, magnetic actuators, thermal actuators, magnetostrictive actuators, piezoelectric actuators, and the like.

Stops 1018 and 1020 are structural elements for limiting the translation of beam portion 1014 along the y-direction.

Prior to operation of microswitch 1000, latching mechanism 1010 is in its as-formed configuration, wherein it positions movable element 318 such that contact 314 is not in physical contact with contact 316.

When a voltage is applied between electrode 1016 and beam portion 1014, latching mechanism 1010 buckled-beam portion 1014 is attracted toward electrode 1016. This actuates latching mechanism 1010 to force buckled-beam portion 1014 through “snap-through.” Upon snap-through, buckled-beam portion 1014 buckles toward electrode 1016 until its movement is stopped by contact with stops 1018 and 1020. As a result, movable element 318 is repositioned and forces contact 314 against contact 316. In some embodiments, actuation of latching mechanism 1010 applies a mechanical prebias to movable element 1002, which mitigates contact resistance, as discussed above.

The inclusion of latching mechanism 1010 in microswitch 1000 provides several advantages over microswitches of the prior art. For example, it can reduce overall cost by enabling anchors 622 and 624, magnetic poles 322 and 324, armature 1006 and movable element 318 to be fabricated at the same time (e.g., during the fabrication of ferromagnetic layer 620, as described above). Further, the inclusion of latching mechanism 1010 mitigates the need for precision alignment of modules 306 and 308 prior to their bonding, further reducing production cost. The relaxed alignment tolerance arises from the fact that the relative initial position of contacts 314 and 316 is fixed during their simultaneous formation and does not require control during the bonding process.

It should be noted that latching mechanism 1010 represents only one example of a one-time, bi-stable mechanism that can be used to establish contact between two previously disconnected structural elements. Furthermore, although microswitch 1000 includes an integrated actuator for actuating latching mechanism 1010, it will be clear to one skilled in the art, after reading this Specification, how to make and use alternative embodiments of the present invention wherein an external force is applied to actuate an integrated latching mechanism and “set” a microswitch into a normally closed configuration.

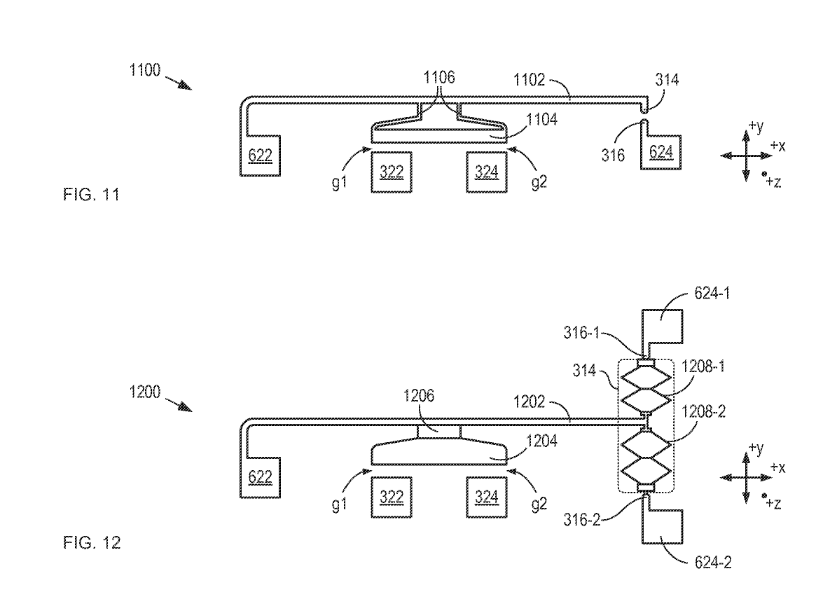

FIG. 11 depicts a schematic drawing of a top view of salient features of a second alternative embodiment in accordance with the present invention. Microswitch 1100 comprises movable element 1102, armature 1104, anchors 622 and 624, and magnetic poles 322 and 324. Microswitch 1100 is analogous to microswitch 300; however, microswitch 1100 is a normally open, single-pole, single-throw (i.e., form A) switch.

Movable element 1102 is analogous to movable element 318.

Armature 1104 is analogous to armature 320, described above. In contrast to microswitch 300, however, movable element 1102 and armature 1104 and are formed at the same time from a continuous portion of ferromagnetic layer 620. Furthermore, armature 1104 is attached to movable element 1102 via ribs 1104, which have high magnetic reluctance and electrical resistance to substantially electrically and magnetically isolate movable element 1102 and armature 1104. In some embodiments, movable element 1102 and armature 1104 are interconnected via an isolator, such as interposer 626 described above.

In operation, a current flow through coils 504 develops a magnetic force on armature 1104, which pulls movable element in the negative y-direction and forces contact 314 into physical and electrical contact with contact 316.

FIG. 12 depicts a schematic drawing of a top view of salient features of a third alternative embodiment in accordance with the present invention. Microswitch 1200 comprises movable element 1202, armature 1204, interposer 1206, springs 1208-1 and 1208-2, anchors 622, 624-1, and 624-2, and magnetic poles 322 and 324. Microswitch 1200 is analogous to microswitch 300; however, microswitch 1000 is a make-before-break, single-pole, double-throw (i.e., form D) switch.

Movable element 1202 is analogous to movable element 318.

Armature 1204 is analogous to armature 320, described above. Armature 1204 is attached to movable element 1202 via interposer 1206, which substantially electrically and magnetically isolates movable element 1202 and armature 1204 in similar fashion to interposer 626 described above.

Springs 1208-1 and 1208-2 are resilient “spring-like” elements that can provide physical and electrical connectivity between contact 314 and contacts 316-1 and 316-2. Although springs 1208-1 and 1208-2 are depicted as conventional folded-leaf springs, it will be clear to one skilled in the art that many alternative spring designs are suitable for use with the present invention.

When movable element 1202 is in its quiescent position, contact 314 is in physical and electrical contact with contact 316-1 and spring 1208-1 is slightly compressed. Upon flow of a current through coils 504, a magnetic force on armature 1204, which pulls movable element in the negative y-direction. As movable element 1202 moves, contact 314 makes contact with contact 316-2 before spring 1208-1 has become fully relaxed. As movable element 1202 continues to move, spring 1208-2 compresses while contact 314 is pulled free from, and breaks contact with, contact 316-1.

It is to be understood that the disclosure teaches just exemplary embodiments of the present invention and that many variations of the invention can easily be devised by those skilled in the art after reading this disclosure and that the scope of the present invention is to be determined by the following claims.

What is claimed is:

1. A microswitch comprising:
(1) a first substrate that defines a first plane;
(2) a first coil operative for providing a magnetic field, the first coil being substantially planar in a second plane that is substantially parallel with the first plane, wherein the first coil and the first substrate are monolithically integrated;
(3) an electrical path between a first terminal and a second terminal, the electrical path comprising;
(a) a first contact that is selectively movable in a third plane that is substantially parallel with the first plane, the first contact having a first position and a second position in the third plane, and the first contact being in electrical communication with the first terminal; and
(b) a second contact that is in electrical communication with the second terminal;
wherein the first contact and second contact are electrically connected when the first contact is in the first position and not electrically connected with the first contact is in the second position; and
(4) a closed-loop magnetic path operative for channeling the magnetic field through an armature that is mechanically coupled with the first contact;
wherein the magnetic field gives rise to a force on the armature that moves the first contact between the first position and the second position; and
wherein the electrical path and the closed-loop magnetic path are path independent.

2. The microswitch of claim 1, wherein the first contact is in the first position in the absence of the magnetic field.

3. The microswitch of claim 2 further comprising (5) a third contact that is in electrical communication with a third terminal, wherein the third contact and first contact are not electrically connected when the first contact is in the first position, and wherein the third contact and the first contact are electrically connected when the first contact is in the second position.

4. The microswitch of claim 3, wherein the first contact, the second contact, and third contact are dimensioned and arranged such that the first contact is electrically connected with both of the second contact and the third contact when the first contact is in a third position that is between the first position and the second position.

5. The microswitch of claim 1, wherein the electrical path further comprises:
(c) a first anchor that is immovable with respect to the first substrate;
(d) a movable element that is attached to the first anchor at a first end, the movable element having a second end that comprises the first contact, the second end being selectively movable along a direction that lies in the third plane, and the movable element and the armature being mechanically coupled; and
(e) a second anchor that is immovable with respect to the first substrate, the second anchor comprising the second contact.

6. The microswitch of claim 1 further comprising (5) an interposer, the interposer being between the movable element and the armature, and the interposer being operative for providing electrical and magnetic isolation between the movable element and the armature.

7. The microswitch of claim 1 further comprising (5) a second coil that is substantially planar in a fourth plane that is substantially parallel with the first plane, the first and second coils being collectively operative for generating the magnetic field, wherein the second coil and the first substrate are monolithically integrated.

8. The microswitch of claim 1 further comprising (5) a bi-stable latching mechanism having an actuated position and an unactuated position, wherein the first contact is in the first position when the bi-stable latching mechanism is in the actuated position, and wherein the first contact is not electrically connected with the second contact when the bi-stable latching mechanism is in the unactuated position.

9. A microswitch comprising:
(1) a first substrate that defines a first plane, the first substrate comprising;
(a) a first coil operative for providing a magnetic field, the first coil being substantially planar in a second plane that is substantially parallel with the first plane, wherein the first coil and the first substrate are monolithically integrated; and
(b) a first magnetic coupler, the first magnetic coupler being surrounded by the first coil;
(2) a second substrate comprising;
(a) a first anchor that is immovable with respect to the second substrate;
(b) a movable element that is attached to the first anchor at a first end, the movable element having a second end that is selectively movable in a third plane that is substantially parallel with the first plane, the second end comprising a first contact that is in electrical communication with a first terminal;
(c) an armature, the armature being mechanically coupled with the movable element;
(d) a first magnetic pole that is separated from the armature by a first working gap; and
(e) a first through-wafer magnetic via, the first through-wafer magnetic via being magnetically coupled with the first magnetic pole;
wherein the first substrate and second substrate are joined such that the first through-wafer magnetic via and the first magnetic coupler are bonded at a first bonded interface;
wherein the first through-wafer magnetic via, the first magnetic coupler, the first magnetic pole, the first working gap, and the armature collectively define a portion of a closed-loop magnetic path; and
wherein the first anchor and movable element collectively define a portion of an electrical path that is path independent from the closed-loop magnetic path.

10. The microswitch of claim 9, wherein the second substrate further comprises (f) an interposer, the interposer being between the movable element and the armature, and the interposer being operative for providing electrical and magnetic isolation between the movable element and the armature.

11. The microswitch of claim 10, wherein the interposer and the second substrate are monolithically integrated.

12. The microswitch of claim 9, wherein the second substrate further comprises (f) a second anchor that is immovable with respect to the second substrate, the second anchor comprising a second contact that is in electrical communication with a second terminal, wherein the first contact is in a first position when the microswitch is in its quiescent position, the first contact and second contact being electrically connected when the first contact is in the first position.

13. The microswitch of claim 12, wherein the second substrate further comprises (g) a bi-stable latching mechanism having an actuated position and an unactuated position, the bi-stable latching mechanism being operative for putting the first contact into the first position.

14. The microswitch of claim 12 further comprising (g) a third anchor that is immovable with respect to the second substrate, the third anchor comprising a third contact, wherein the third contact and first contact are not physically connected when the first contact is in the first position, and wherein the third contact and the first contact are electrically connected when the first contact is in a second position in the third plane.

15. The microswitch of claim 14, wherein the movable element, the second anchor, and the third anchor are dimensioned and arranged such that the first contact is electrically connected with both of the second contact and the third contact when the first contact is in a third position that is between the first position and the second position.

16. A method for forming a microswitch, the method comprising:
(1) providing a first substrate that defines a first plane, the first substrate comprising;
(a) a first magnetic coupler; and
(b) a first coil for generating a magnetic field, the first coil being planar in a second plane that is substantially parallel with the first plane, wherein the first coil surrounds the first magnetic coupler;
(2) providing a second substrate, the second substrate comprising;
(a) a first anchor that is immovable with respect to the second substrate;
(b) a movable element that is attached to the first anchor at a first end, the movable element having a second end that is dimensioned and arranged to be selectively movable in a third plane that is substantially parallel with the first plane, wherein the second end includes a first contact;
(c) a second anchor that is immovable with respect to the second substrate, the second anchor comprising a second contact;
(d) an armature, the armature being mechanically coupled with the movable element;
(e) a first magnetic pole that is separated from the armature by a first working gap; and
(f) a first through-wafer magnetic via, the first through-wafer magnetic via being magnetically coupled with the first magnetic pole; and
(3) joining the first substrate and second substrate such that the first through-wafer magnetic via and the first magnetic coupler are bonded at a first bonded interface;
wherein the first substrate and second substrate are joined such that (1) the first through-wafer magnetic via, the first magnetic coupler, the first magnetic pole, the first working gap, and the armature collectively define a portion of a closed-loop magnetic path, (2) the first anchor, the second anchor, and the movable element are included in an electrical path between a first terminal and a second terminal, the electrical path and the closed-loop magnetic path being path independent, and (3) the first contact is in electrical communication with the first terminal and the second contact is in electrical communication with the second terminal.

17. The method of claim 16, wherein the first substrate and second substrate are joined such that the first contact is in physical contact with the second contact.

18. The method of claim 16, wherein the second substrate is provided such that it further comprises a third anchor that is immovable with respect to the second substrate, the third anchor including a third contact that is in electrical communication with a third terminal when the first substrate and second substrate are joined, wherein the first substrate and second substrate are joined such that the first contact is not in physical contact with the third contact.

19. The method of claim 16 further comprising (4) actuating a bi-stable latching mechanism to put the first contact into physical contact with the second contact, wherein the second substrate is provided such that it further comprises the bi-stable latching mechanism, and wherein the first substrate and second substrate are joined such that the first contact is not in physical contact with the second contact.

20. The method of claim 16, wherein the second substrate is provided by operations comprising:
providing a third substrate comprising the first through-wafer magnetic via;
forming a first spacer pad that is in physical contact with the first through-wafer magnetic via;
forming the second anchor on the third substrate;
forming a first layer on a fourth substrate, the first layer comprising a first material that is ferromagnetic, wherein the first layer is formed such that it comprises the first anchor, the movable element, the armature, and the first magnetic pole;
joining the third substrate and the fourth substrate such that the first anchor and the first spacer pad are bonded; and
removing the fourth substrate.

21. The method of claim 20, wherein the second substrate is provided by operations further comprising:
providing the fourth substrate such that it includes a release layer, wherein the first layer is formed on the release layer;
partially removing the release layer such that the movable element is mechanically active relative to the fourth substrate and the first anchor is immovable with respect to the fourth substrate; and
aligning the third and fourth substrates such that the first contact is in physical contact with the second contact prior to joining the third and fourth substrates.

22. The method of claim 20, wherein the second substrate is provided by operations further comprising:
forming the first layer such that it further includes a bi-stable latching mechanism;
aligning the third and fourth substrates such that the first contact is not in physical contact with the second contact prior to joining the third and fourth substrates; and
actuating the bi-stable latching mechanism to put the first contact into physical contact with the second contact.
